(19) United States
(12) Patent Application Publication
(10) Pub. No.: US 2009/0195804 A1
(43) Pub. Date: Aug. 6, 2009

(54) Printing system, printing system controlling method, printing system controlling program, and printing apparatus

(75) Inventor: Shoji Kojima, Chino-shi (JP)

Correspondence Address: EDWARDS ANGELL PALMER & DODGE LLP, P.O. BOX 55874, BOSTON, MA, 02205, US

(73) Assignee: Seiko Epson Corporation, Tokyo (JP)

(21) Appl. No.: 12/322,737

(22) Filed: Feb. 6, 2009

(30) Foreign Application Priority Data
Feb. 6, 2008 (JP) 2008-026539
Dec. 4, 2008 (JP) 2008-309541

(51) Int. Cl. H04N 1/60

(52) U.S. Cl. 358/1.9

(57) ABSTRACT

A printing system includes a circular record medium and a printing apparatus. The circular record medium includes: a data record surface on which electronic data are recorded; a label surface which is a rear surface of the data record surface and on which the printing apparatus prints an image; and a wireless IC tag which is attached to or embedded in the label surface. The printing apparatus includes: a wireless IC reader/writer which reads and writes electronic data from and to the wireless IC tag; a data record unit which writes electronic data on the data record surface; a data input unit which inputs electronic data from the outside; a specific image record unit which writes specific image data associated with the electronic data input from the data input unit to the wireless IC tag by use of the wireless IC reader/writer, upon writing the electronic data input from the data input unit on the data record surface by use of the data record unit; and a label print unit which reads the specific image data from the wireless IC tag by use of the wireless IC reader/writer and prints an image which is based on the read specific image data on the label surface.

### BACKGROUND

1. Technical Field

The present invention relates to a printing system, a printing system controlling method, a printing system controlling program, and a printing apparatus, and particularly to a label printing process of printing an image on a label surface of a circular record medium.

2. Related Art

There is well known a non-contact wireless IC tag such as an NFC (Near Field Communication) tag, which is a representative example of an RFID (radio Frequency-IDentification) tag, including a small IC chip and a chip antenna and being supplied with power by electromagnetic induction to electrically write or read electronic data to or from an IC chip. The wireless IC tag is capable of recording various electronic data to a small IC chip to read the electronic data or additionally write electronic data by use of radio waves or electromagnetic waves. Therefore, it is possible to use the recorded electronic data by attaching or embedding the wireless IC tag to or in various products (where hereafter, a meaning that the wireless IC tag is embedded is implied even when only an expression that the wireless IC tag is attached is described) and by recording the electronic data to the wireless IC tag. For example, as a product to which the wireless IC tag is attached, a CD (Compact Disk) medium to which the wireless IC tag is attached is disclosed in JP-A-2003-36432.

On the other hand, JP-A-2004-122583 and JP-A-2006-25331 disclose a printing apparatus which prints a predetermined image on a label surface of a circular record medium (for example, CD-R) capable of recording electronic data. In addition to the printing apparatus capable of performing the label printing process, there is also known a printing apparatus equipped with a data input unit (for example, a memory card drive) inputting electronic data from the outside and a data record unit (for example, a CD/DVD drive) writing electronic data to the circular record medium.

These printing apparatuses are capable of storing (backup) image data in a memory card storing photos photographed with a digital camera, for example, to a CD/DVD medium and printing a design expressing the photos stored in the CD/DVD medium to easily know the contents stored in the CD/DVD medium.

However, it is difficult to realize a printing apparatus performing the label printing process inside a CD/DVD drive and it is difficult to simultaneously perform a backup process and the label printing process on image data, in that the printing apparatus has a restrictive configuration, that is, a lens inside the CD/DVD drive is weak in contamination and ink having a bad influence on the lens is ejected in a printing process. For that reason, it is necessary to extract the CD/DVD medium from the CD/DVD drive after performing the backup process on the image data and then moving the CD/DVD medium to a printing tray for only the label printing process to perform the label printing process.

In this case, when the label printing process is performed immediately after the backup process, it is not possible to know which contents are contained in the CD/DVD medium from the appearance. Therefore, an operation of attaching a sticky note to the CD/DVD medium after the backup process or an operation of knowing the contents by inserting the CD/DVD medium into the CD/DVD drive immediately before the label printing process is necessary. In addition, it is necessary to mount a memory card which is a foundation of the design for the label printing process.

In particular, it is considered that a user having plural memory cards first performs the backup process on all the memory cards together and postpones performing the label printing process on each of the memory cards in many cases, in that a series of processes of performing the label printing process after the backup process are complicated and it takes much time to perform the series of processes. In such a circumstance, since the above-described operations are necessary in the subsequent label printing process, it is considered that it is very difficult to perform the label printing process. Moreover, a backup function is used for reusing the memory card without using a host apparatus such as a personal computer (PC) and a method of copying photos of a filled memory card to the CD/DVD medium and then immediately deleting the photos of the memory card is generally used. Then, the design for the label printing process has to be read from the CD/DVD medium, for example.

### SUMMARY

An advantage of some aspects of the invention is that it provides a printing system, a printing system controlling method, a printing system controlling program, and a printing apparatus capable of simply and surely performing a series of processes of writing electronic data input from the outside to a circular record medium and printing an image associated with the written electronic data on a label surface of the circular record medium.

According to an aspect of the invention, there is provided a printing system including a circular record medium and a printing apparatus in which the circular record medium includes a data record surface on which electronic data are recorded, a label surface which is a rear surface of the data record surface and on which the printing apparatus prints an image, and a wireless IC tag which is attached to or embedded in the label surface and in which the printing apparatus includes a wireless IC reader/writer which reads and writes electronic data from and to the wireless IC tag, a data record unit which writes electronic data on the data record surface, and a data input unit which inputs electronic data from the outside. The printing system further includes a specific image record unit and a label print unit in order to perform a series of processes of writing the electronic data input from the outside to the circular record medium and printing an image associated with the written electronic data on the label surface of the circular record medium. The specific image record unit writes specific image data associated with the electronic data input from the data input unit to the wireless IC tag by use of the wireless IC reader/writer, upon writing the electronic data input from the data input unit on the data record surface by use of the data record unit. In addition, the label print unit reads the specific image data from the wireless IC tag by use of the wireless IC reader/writer and prints an image which is based on the read specific image data on the label surface.

With such a configuration, it is possible to use the specific image data read from the wireless IC tag of the circular record medium by use of the wireless IC reader/writer for performing a printing process, upon performing the label printing process on the label surface of the circular record medium. That is, it is possible to know which contents are contained in the circular record medium by use of the data record unit, or perform the label printing process by use of the data input unit or the data record unit without inputting image data for the label printing process.

Accordingly, it is possible to simply and surely perform the series of processes of writing the electronic data input from the outside to the circular record medium and printing the image associated with the written electronic data on the label surface of the circular record medium. In particular, advantages are apparent, when the label printing process is performed immediately after the writing (for example, a backup process) on the electronic data onto the data record surface or when the label printing process is performed together after the repeated writing on only the electronic data onto the data record surface.

In the printing system, the specific image data may be image data for a label printing process, the image data indicating information on the electronic data input from the data input unit. That is, the data in the wireless IC tag indicate information written in the circular record medium. Accordingly, an image or a title appropriately expressing contents of the electronic data input from the outside to the circular record medium is subjected to the label printing process.

In the printing system, the electronic data input from the data input unit may be image data and the image data for the label printing process are thumbnail images of the image data. That is, the image data for the label printing process are data having a size sufficiently smaller than that of the data in the circular record medium. Accordingly, a burden on the wireless IC tag or the wireless IC reader/writer is reduced.

In the printing system, the electronic data input from the data input unit may be musical data. Accordingly, the image or the title appropriately expressing the contents of the circular record medium is subjected to the label printing process, even when the data in the circular record medium are not the image data.

The technical spirit according to the invention is understandable from the invention other than the above-described printing system. For example, the invention is understandable by a printing system controlling method including steps corresponding to the units of the above-described printing system. That is, in the printing system including the circular record medium and the printing apparatus, the method includes: a specific image recording step of writing specific image data associated with the electronic data input from the data input unit to the wireless IC tag by use of the wireless IC reader/writer, upon writing the electronic data input from the data input unit on the data record surface by use of the data record unit; and a label printing step of reading the specific image data from the wireless IC tag by use of the wireless IC reader/writer and printing an image which is based on the read specific image data on the label surface.

The invention is understandable by a printing system controlling program causing a computer to execute functions corresponding to the units of the above-described printing system. That is, in the printing system including the circular record medium and the printing apparatus, the program causes a computer to execute: a specific image recording function of writing specific image data associated with the electronic data input from the data input unit to the wireless IC tag by use of the wireless IC reader/writer, upon writing the electronic data input from the data input unit on the data record surface by use of the data record unit; and a label printing function of reading the specific image data from the wireless IC tag by use of the wireless IC reader/writer and printing an image which is based on the read specific image data on the label surface.

The invention is understandable by only a printing apparatus described above. That is, a printing apparatus includes: a wireless IC reader/writer which reads and writes electronic data from and to a wireless IC tag attached to or embedded in a label surface of a circular record medium; a data record unit which writes electronic data on a data record surface of the circular record medium; a data input unit which inputs electronic data from the outside; a specific image record unit which writes specific image data associated with the electronic data input from the data input unit to the wireless IC tag by use of the wireless IC reader/writer, upon writing the electronic data input from the data input unit on the data record surface by use of the data record unit; and a label print unit which reads the specific image data from the wireless IC tag by use of the wireless IC reader/writer and prints an image which is based on the read specific image data on the label surface.

The printing apparatus may further include a carriage. The IC reader/writer may be provided in the carriage.

### BRIEF DESCRIPTION OF THE DRAWINGS

The invention will be described with reference to the accompanying drawings, wherein like numbers reference like elements.

FIG. 1 is a diagram illustrating the outer appearance of an exemplified printing system according to the invention.

FIG. 2 is a block diagram illustrating the exemplary overall configuration of the printing system.

FIG. 3 is a schematic diagram illustrating an example of arrangement of an NFC reader/writer.

FIG. 4 is a flowchart illustrating a control process performed by a control unit.

FIGS. 5A and 5B are diagrams illustrating user operation screens in a backup process and a label printing process.

FIG. 6 is a diagram illustrating the configuration of an NFC tag according to a modified example.

### DESCRIPTION OF EXEMPLARY EMBODIMENTS

Hereinafter, an embodiment of the invention will be described in the following order with reference to the drawings:

1. Overall Configuration of Printing System,

2. Operation of Printing Apparatus in Label Printing Process,

3. Modified Example, and

4. Conclusion.

### 1. OVERALL CONFIGURATION OF PRINTING SYSTEM

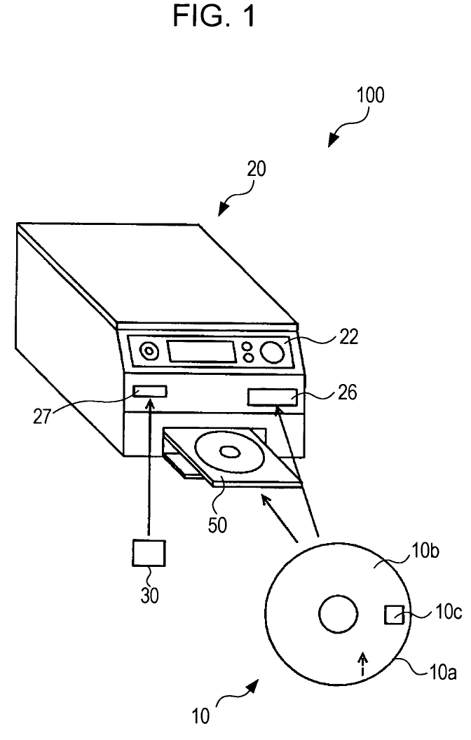

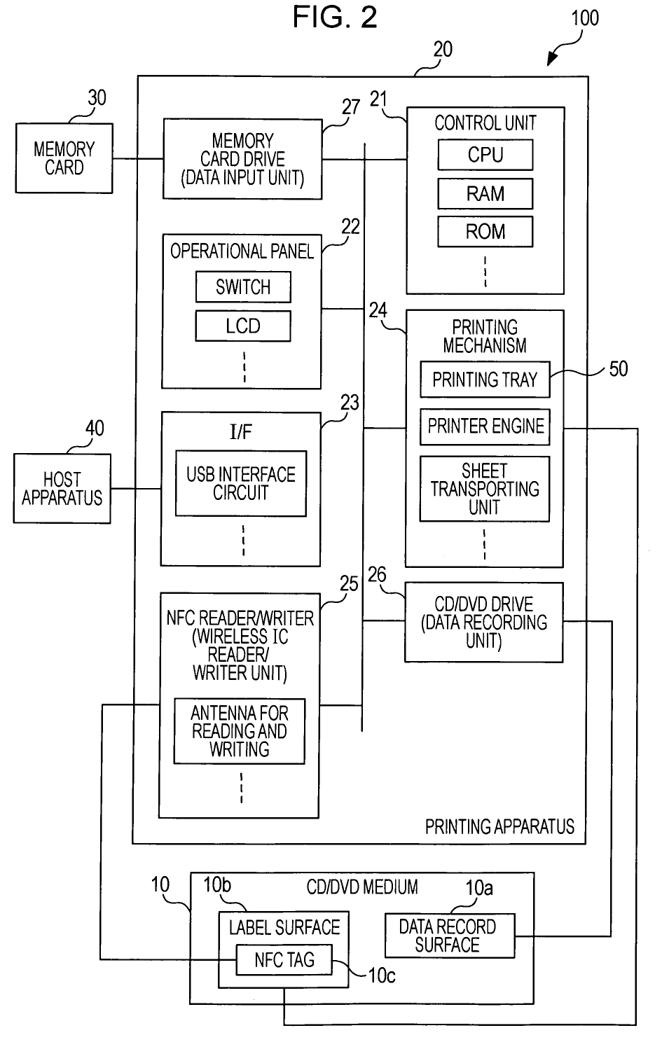

FIG. 1 is a diagram illustrating the outer appearance of a printing system 100 according to an embodiment of the invention. FIG. 2 is a block diagram illustrating the configuration of the printing system 100. In FIGS. 1 and 2, the printing system 100 is a system which includes a CD/DVD medium 10 as a circular record medium and a printing apparatus 20.

The CD/DVD medium 10 includes a data record surface 10a on which electronic data (file) are recorded, a label surface 10b which is a rear surface of the data record surface 10a and on which the printing apparatus 20 is able to print an image, and a wireless IC tag 10c which is attached to the label surface 10b. The CD/DVD medium 10 includes a CD-R, a CD-RW, a DVD-R, a DVD-RW, or the like which is well known and used to back up the electronic data recorded in the memory card 30 or the like. In particular, the CD/DVD medium 10 is equipped with the wireless IC tag 10c. The wireless IC tag 10c is a non-contact wireless IC tag such as an RFID tag which includes a small IC chip and a chip antenna and is supplied with power by electromagnetic induction to electrically write or read electronic data to or from an IC chip. In this embodiment, a well-known NFC tag is used. Hereinafter, the wireless IC tag 10c is expressed as an NFC tag 10c.

The printing apparatus 20 is a printer which includes a control unit 21, an operational panel 22, an I/F 23, a printing mechanism 24, an NFC reader/writer 25 as a wireless IC reader/writer, a CD/DVD drive 26 as a data record unit, and a memory card drive 27 as a data input unit and receive a control command from a printer driver in a host apparatus 40 to perform a printing process. In addition, the printing apparatus 20 is a so-called direct printer which is directly connected to the memory card 30 without the host apparatus 40 to perform a printing process. In addition, the electronic data in the memory card 30 can be backed up to the CD/DVD medium 10 without the host apparatus 40.

The control unit 21 is a unit which includes a CPU, a RAM, a ROM, a memory controller, a non-volatile RAM, and the like and performs a process of allowing the printing mechanism 24 to produce prints of contents according to printing job data received from the host apparatus 40, a process of transporting status information on a status (a usable function, an amount of residual consumption goods, or the like) of the printing apparatus 20 to an apparatus which requests the status information.

The CPU controls constituent elements of the control unit 21 on the whole in accordance with programs stored in the ROM or the like. The RAM is a memory used to temporarily store the printing job data received by the I/F 23 or the like, data generated by the CPU, and the like on the basis of the printing job data. The ROM is a non-volatile memory in which various programs to be loaded and executed on the RAM by the CPU are stored in a compressed state. The memory controller performs a process of transporting data from the I/F 23 or the like to the RAM in accordance with a command of the CPU, a process of transporting data from the RAM to a printer engine in the printing mechanism 24 in accordance with a command of the CPU, and the like. The non-volatile RAM is a storage unit which various kinds of information to be maintained even thought power supplied is stopped and is a non-volatile memory (for example, an EEPROM or an NVRAM) being equipped in the printing apparatus 20 (the control unit 21) and performing a rewriting function.

The operational panel 22 is a user interface unit between a user and the printing apparatus 20 (the control unit 21). The operational panel 22 includes a plurality of press button switches receiving user operations and an LCD (Liquid Crystal Display) displaying various messages on statuses of the printing apparatus 20. Here, the user operations refer to an operation of receiving a command of a print layout, an operation of receiving a command for selecting image data of a print target, and an operation of receiving a request for a backup process of the electronic data in the memory card 30, for example.

The I/F 23 having a USB interface circuit and the like is an interface which communicates (exchanges information) with the host apparatus 40.

The printing mechanism 24 is a mechanism which includes a sheet transporting unit, a printing tray 50, and the printer engine and actually perform a printing process on a fed sheet and a label printing process on the label surface 10b of the CD/DVD medium 10 placed in the printing tray 50.

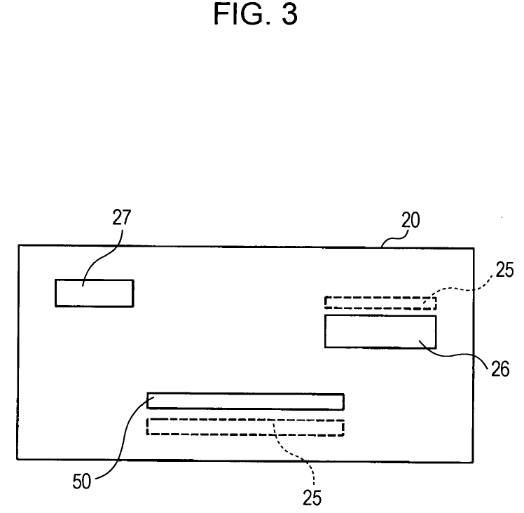

The NFC reader/writer 25 includes a reading and writing antenna for performing wireless communication with the chip antenna of the NFC tag 10c to read and write electronic data from and to the IC chip, and is capable of reading and writing the electronic data from and to the NFC tag 10c in a wireless communication manner in accordance with a command of the control unit 21. As shown in FIG. 3, the NFC reader/writers 25 are each disposed at least in the vicinity of the CD/DVD drive 26 and in the vicinity of the printing tray 50, and is capable of performing wireless communication with the NFC tag 10c of the CD/DVD medium 10 inserted into the CD/DVD drive 26 or the NFC tag 10c of the CD/DVD medium 10 placed in the printing tray 50.

For example, in accordance with a command of the control unit 21, the CD/DVD drive 26 reads, deletes, or rewrites the electronic data recorded in the data record surface 10a of the CD/DVD medium 10, or newly writes electronic data on the data record surface 10a.

The memory card drive 27 is able to input the electronic data from the outside, that is, the electronic data in the memory card 30 in this embodiment. In addition, for example, in accordance with a command of the control unit 21, the memory card drive 27 deletes or rewrite the electronic data recorded in the memory card 30 or newly writes electronic data to the memory card 30.

The host apparatus 40 is a personal computer (which is a computer to which an OS, a Web browser, and the like are installed) or the like which has a general configuration connected to the printing apparatus 20 and to which a program and a utility program developed for the printing apparatus 20 are installed. The program used to control the printing apparatus 20 is a program (so-called printer driver) which generates the printing job data to be supplied to the printing apparatus 20 on the basis of data on a print target document supplied from an application program (and OS). On the other hand, the utility program is a program which supplies a user for the host apparatus 40 with an environment in which reserve job data (which are mainly stored by the user) stored in the printing apparatus 20 can simply be used.

In the printing system 100 having the above-described configuration, particularly the control unit 21 functionally includes: a specific image record unit which writes specific image data associated with the electronic data input from the memory card drive 27 to the NFC tag 10c by use of the NFC reader/writer 25 upon writing the electronic data of the memory card drive 27 input from the memory card drive 27 onto the data record surface 10a of the CD/DVD medium 10 by use of the CD/DVD drive 26; and a label print unit which reads the specific image data from the NFC tag 10c by use of the NFC reader/writer 25 and prints an image which is based on the read specific image data on the label surface 10b of the CD/DVD medium 10.

In this embodiment, the electronic data input from the memory card drive 27, that is, the electronic data in the memory card 30 are image data photographed by a digital camera, musical data, or the like. In addition, the specific image data are image data for the label printing process indicating information on the electronic data input from the memory card drive 27. That is, the image data indicating the information written to the CD/DVD medium 10 are written to the NFC tag 10c. Here, the image data for the label printing process may be the image data, but it is preferable that the image data for the label printing process are small image data (thumbnail data) having a size sufficiently smaller than that of the image data in consideration of a capacity of a memory. In addition, printing images for the label printing process indicating contents of the image data or the musical data are also assumed.

Accordingly, an image or a title appropriately expressing the contents of the electronic data input from the memory card 30 is subjected to the label printing process on the CD/DVD medium 10. In addition, even though the electronic data in the memory card drive 27, that is, the data in the CD/DVD medium 10 are not image data, an image or a title appropriately expressing the contents of the CD/DVD medium 10 is subjected to the label printing process.

Alternatively, data such as the musical data, some of the musical data, a file name, or an asset data (MPV manifest) having a size sufficiently smaller than that of the electronic data in the CD/DVD medium 10, a photograph date of an image, a photograph location of an image photographed by use of a GPS or the like, information (for example, a title) on the image photograph designated by a user, and the like may be written in the NFC tag 10c. In addition, the photograph date of an image, the photograph location of an image, the title, and the like may be used in the label printing process likewise with the image data. The photograph date of an image, the photograph location of an image, the title, and the like are the same as the specific image data.

### 2. OPERATION OF PRINTING APPARATUS IN LABEL PRINTING PROCESS

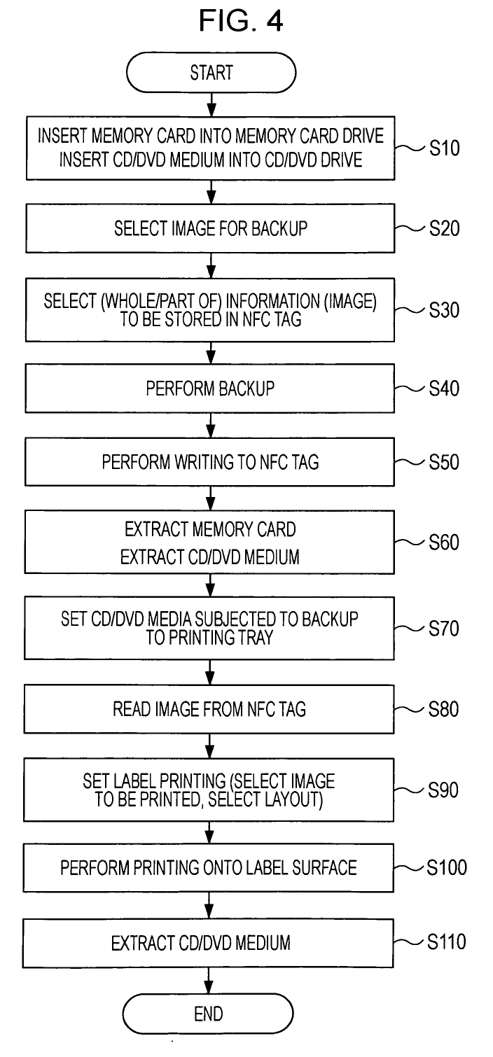

FIG. 4 is a flowchart illustrating a control process performed in the label printing process in accordance with a predetermined program stored in the ROM, for example, by the control unit 21 of the printing apparatus 20.

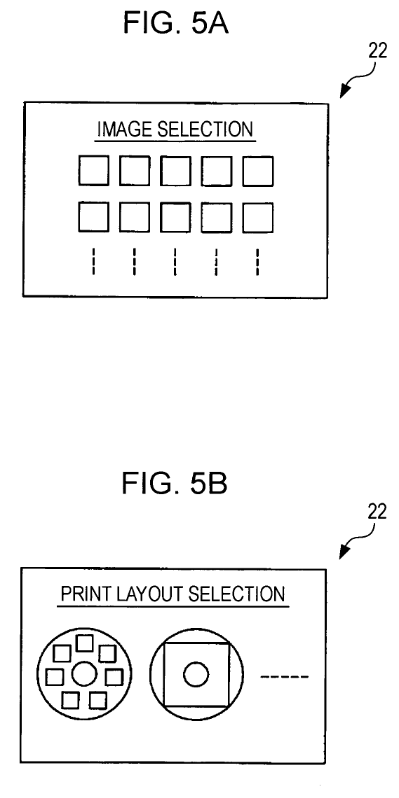

In FIG. 4, in Step S10 (hereinafter, the term Step is omitted), when the memory card 30 recording image data, for example, is inserted into the memory card drive 27 and the CD/DVD medium 10 is inserted into the CD/DVD drive 26, the memory card 30 is recognized and the image data in the memory card 30 is prepared to be backed up to the CD/DVD medium 10. Subsequently, in S20, a selection screen used to select an image to be backed up to the CD/DVD medium 10 is displayed on the LCD of the operational penal 22, as shown in FIG. 5A, and the image is selected through the user operation in the operational panel 22. When the operation in S20 is completed, the selection screen as the same as that in FIG. 5A is displayed, and a specific image data to be stored in the NFC tag 10c is selected (and/or input) through the user operation in the operational panel 22 in S30. When the operation in S30 is completed, the image data in the memory card 30 selected through the user operation in the operational panel 22 is written (backed up) to the CD/DVD medium 10 in subsequent S40. Subsequently, in S50, the specific image data selected (input) through the user operation in the operational panel 22 is written to the NFC tag 10c. Subsequently, in S60, when the memory card 30 is extracted from the memory card drive 27 and the CD/DVD medium 10 is extracted from the CD/DVD drive 26, the series of the backup process ends.

Subsequently, when the CD/DVD medium 10 subjected to the backup process is set in the printing tray 50 in S70, the specific image data are read from the NFC tag 10c in subsequent S80. Subsequently, in S90, the selection screen as the same as that in FIG. 5A or a selection screen used to select a print layout for the label printing process in the CD/DVD medium 10 shown in FIG. 5B is displayed, and then an input for setting the label printing process through the user operation in the operational panel 22, such as selection of an image to be subjected to the label printing process or selection of the print layout, is received. When the operation in S90 is completed, a predetermined image is printed onto the label surface 10b of the CD/DVD medium 10 on the basis of the set label printing process in subsequent S100. Subsequently, in S110, when the CD/DVD medium 10 is extracted from the printing tray 50, the series of label printing process ends.

### 3. MODIFIED EXAMPLE

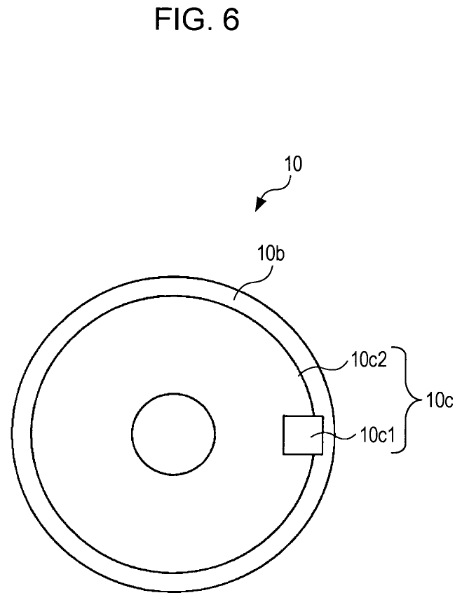

As shown in FIG. 6, the NFC tag 10c may have configuration which includes an IC chip 10c1 and a chip antenna 10c2 arranged in a circumferential direction of the label surface 10b of the CD/DVD medium 10. With such a configuration, wireless communication between the NFC reader/writer 25 and the chip antenna 10c2 is further improved.

### 4. CONCLUSION

In the printing system 100 having the above-described configuration, when an image is subjected to the label printing process onto the label surface 10b of the CD/DVD medium 10, the specific image data read from the NFC tag 10c of the CD/DVD medium 10 by use of the NFC reader/writer 25 can be used in a printing process. That is, it is possible to know which contents are contained in the CD/DVD medium 10 by use of the CD/DVD drive 26. Moreover, it is possible to perform the label printing process by use of the memory card drive 27 or the CD/DVD drive 26 without inputting the image data for the label printing process.

In this way, it is possible to simply and surely perform the series of processes of writing the electronic data input from the memory card 30 to the CD/DVD medium 10 and printing an image associated with the written electronic data onto the label surface 10b of the CD/DVD medium 10. In particular, advantages are apparent, when the label printing process is performed immediately after the writing (for example, the backup process) on the electronic data onto the data record surface 10a or when the label printing process is performed together after the repeated writing on only the electronic data onto the data record surface 10a.

The embodiment of the invention has been described in detail with reference to the drawings, but the invention is applicable to other aspects.

For example, in the above-described embodiment, at least two NFC reader/writers 25 are arranged in the vicinity of the CD/DVD drive 26 and in the vicinity of the printing tray 50. However, when the arrangement location of the CD/DVD drive 26 and the arrangement location of the printing tray 50 are overlapped with each other in a vertical direction, for example, at least one NFC reader/writer 25 is also arranged in the vicinity of the overlapped location likewise.

In the above-described embodiment, the specific image data to be stored in the NFC tag 10c through the user operation in the operational panel 22 are selected in S30 of the flowchart of FIG. 4. However, the specific image data may be automatically prepared on the basis of the image backed up to the CD/DVD medium 10 and selected in S20. For example, the specific image data may be prepared in consideration of using the thumbnail image of the backup image or the like.

The technical spirit according to the invention is understandable from the invention other than the above-described printing system 100. For example, the invention is understandable by a method of controlling the printing system 100. The method includes steps corresponding to the units of the above-described printing system 100. In addition, the invention is understandable by a program of controlling the printing system 100 for causing the control unit 21 to execute functions corresponding to the units of the above-described printing system 100. In addition, the invention is understandable only by the printing apparatus 20 in the above-described printing system 100.

The above-described embodiment is just one embodiment and the invention may be modified or improved in various forms on the basis of the knowledge of a person skilled in the art.

The printing mechanism 24 may include various units such as a print head supplied with ink from ink cartridges to eject the ink, a print head driving circuit controlling ink ejection from the print head, a carriage moving the print head, and sheet transporting unit feeding and discharging a print sheet.

In a printing apparatus (serial printer) equipped with the printing mechanism, it is preferable that the NFC reader/writer 25 is provided in the carriage. When the NFC reader/writer 25 is provided in the carriage, it is possible to appropriately input electronic data from the wireless IC tag attached to or embedded in an arbitrary location of the label surface by moving the carriage provided with the NFC reader/writer without providing the plurality of NFC reader/writer in a printing apparatus in spite of an NFC standard in which a communication range is short.

What is claimed is:

1. A printing system which includes a circular record medium and a printing apparatus,
wherein the circular record medium includes:
a data record surface on which electronic data are recorded;
a label surface which is a rear surface of the data record surface and on which the printing apparatus prints an image; and
a wireless IC tag which is attached to or embedded in the label surface, and
wherein the printing apparatus includes:
a wireless IC reader/writer which reads and writes electronic data from and to the wireless IC tag;
a data record unit which writes electronic data on the data record surface;
a data input unit which inputs electronic data from the outside;
a specific image record unit which writes specific image data associated with the electronic data input from the data input unit to the wireless IC tag by use of the wireless IC reader/writer, upon writing the electronic data input from the data input unit on the data record surface by use of the data record unit; and
a label print unit which reads the specific image data from the wireless IC tag by use of the wireless IC reader/writer and prints an image which is based on the read specific image data on the label surface.

2. The printing system according to claim 1, wherein the specific image data are image data for a label printing process, the image data indicating information on the electronic data input from the data input unit.

3. The printing system according to claim 2,
wherein the electronic data input from the data input unit are image data and the image data for the label printing process are thumbnail images of the image data.

4. The printing system according to claim 2,
wherein the electronic data input from the data input unit are musical data.

5. A method of controlling a printing system which includes a circular record medium and a printing apparatus, in which the circular record medium includes a data record surface on which electronic data are recorded, a label surface which is a rear surface of the data record surface and on which the printing apparatus prints an image, a wireless IC tag which is attached to or embedded in the label surface, and in which the printing apparatus includes a wireless IC reader/writer which reads and writes electronic data from and to the wireless IC tag, and a data record unit which writes electronic data on the data record surface, a data input unit which inputs electronic data from the outside,
the method comprising:
a specific image recording step of writing specific image data associated with the electronic data input from the data input unit to the wireless IC tag by use of the wireless IC reader/writer, upon writing the electronic data input from the data input unit on the data record surface by use of the data record unit; and
a label printing step of reading the specific image data from the wireless IC tag by use of the wireless IC reader/writer and printing an image which is based on the read specific image data on the label surface.

6. A program controlling a printing system which includes a circular record medium and a printing apparatus, in which the circular record medium includes a data record surface on which electronic data are recorded, a label surface which is a rear surface of the data record surface and on which the printing apparatus prints an image, a wireless IC tag which is attached to or embedded in the label surface, and in which the printing apparatus includes a wireless IC reader/writer which reads and writes electronic data from and to the wireless IC tag, and a data record unit which writes electronic data on the data record surface, a data input unit which inputs electronic data from the outside,
the program causing a computer to execute:
a specific image recording function of writing specific image data associated with the electronic data input from the data input unit to the wireless IC tag by use of the wireless IC reader/writer, upon writing the electronic data input from the data input unit on the data record surface by use of the data record unit; and
a label printing function of reading the specific image data from the wireless IC tag by use of the wireless IC reader/writer and printing an image which is based on the read specific image data on the label surface.

7. A printing apparatus comprising:
a wireless IC reader/writer which reads and writes electronic data from and to a wireless IC tag attached to or embedded in a label surface of a circular record medium;
a data record unit which writes electronic data on a data record surface of the circular record medium;
a data input unit which inputs electronic data from the outside;
a specific image record unit which writes specific image data associated with the electronic data input from the data input unit to the wireless IC tag by use of the wireless IC reader/writer, upon writing the electronic data input from the data input unit on the data record surface by use of the data record unit; and
a label print unit which reads the specific image data from the wireless IC tag by use of the wireless IC reader/writer and prints an image which is based on the read specific image data on the label surface.

8. The printing apparatus according to claim 7, further comprising a carriage, wherein the IC reader/writer is provided in the carriage.
